(19) United States
(12) Patent Application Publication
(10) Pub. No.: US 2011/0304649 A1
(43) Pub. Date: Dec. 15, 2011

(54) CHARACTER SELECTION

(75) Inventors: Mark D. Schwesinger, Bellevue, WA (US); John Elsbree, Bellevue, WA (US); Michael C. Miller, Sammamish, WA (US); Guillaume Simonnet, Bellevue, WA (US); Spencer I.A.N. Hurd, Seattle, WA (US); Hui Wang, Redmond, WA (US)

(73) Assignee: MICROSOFT CORPORATION, Redmond, WA (US)

(21) Appl. No.: 12/854,560

(22) Filed: Aug. 11, 2010

Related U.S. Application Data
(60) Provisional application No. 61/353,630, filed on Jun. 10, 2010.

(51) Int. Cl. G09G 5/00; G06T 11/00

(52) U.S. Cl. 345/661; 345/467

(57) ABSTRACT

Character selection techniques are described. In implementations, a list of characters is output for display in a user interface by a computing device. An input is recognized, by the computing device, that was detected using a camera as a gesture to select at least one of the characters.

### RELATED APPLICATIONS

The application claims priority to U.S. Provisional Patent Application No. 61/353,630, filed on Jun. 10, 2010, attorney docket number 329988.01, and titled “Multiple Input character Selection for Search,” the disclosure of which is hereby incorporated by reference in its entirety.

### BACKGROUND

The amount of devices that are made available for a user to interact with a computing device is ever increasing. For example, a user may be faced with a multitude of remote control devices in a typical living room to control a television, game console, disc player, receiver, and so on. Accordingly, interaction with these devices may become quite daunting, as different devices include different configurations of buttons and may interact with different user interfaces.

### SUMMARY

Character selection techniques are described. In implementations, a list of characters is output for display in a user interface by a computing device. An input is recognized, by the computing device, that was detected using a camera as a gesture to select at least one of the characters.

In implementations, an input is recognized, by a computing device, that was detected using a camera as a gesture to select at least one of a plurality of characters displayed by the computing device. A search is performed using the selected at least one of the plurality of characters.

In implementations, one or more computer-readable media comprise instructions that, responsive to execution on a computing device, cause the computing device to perform operations comprising: recognizing a first input that was detected using a camera that involves a first movement of a hand as a navigation gesture to navigate through a listing of characters displayed by a display device of the computing device; recognizing a second input that was detected using the camera that involves a second movement of the hand as a zoom gesture to zoom the display of the characters; and recognizing a third input that was detected using the camera that involves a third movement of the hand as a selection gesture to select at least one of the characters.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ character selection techniques described herein.

FIG. 2 illustrates an example system showing a character selection module of FIG. 1 as being implemented using in an environment where multiple devices are interconnected through a central computing device.

FIG. 3 is an illustration of a system in an example implementation in which an initial search screen is output in a display device that is configured to receive characters as an input to perform a search.

FIG. 4 is an illustration of a system in an example implementation in which a gesture involving navigation through a list of characters of FIG. 3 is shown.

FIG. 5 is an illustration of a system in an example implementation in which a gesture that involves a zoom of the list of characters of FIG. 4 is shown.

FIG. 6 is an illustration of a system in an example implementation in which a gesture that involves selection of a character from the list of FIG. 5 to perform a search is shown.

FIG. 7 is an illustration of a system in an example implementation in which a list having characters configured as group primes is shown.

FIG. 8 is an illustration of a system in an example implementation in which an example of a non-linear list of characters is shown.

FIG. 9 is a flow diagram that depicts a procedure in an example implementation in which gestures are utilized to navigate, zoom, and select characters.

FIG. 10 illustrates various components of an example device that can be implemented as any type of portable and/or computer device as described with reference to FIGS. 1-8 to implement embodiments of the character selection techniques described herein.

### DETAILED DESCRIPTION

Overview

Traditional techniques that were used to enter characters, e.g., to perform a search, were often cumbersome. Therefore, the traditional techniques may interfere with the user's experience with a device.

Character selections techniques are described. In implementations, a list of letters and/or other characters are displayed to a user by a computing device. The user may use a gesture (e.g., a hand motion), controller, or other device (e.g., a physical keyboard) to navigate through the list and select a first character. After selecting the first character, the computing device may output search results to include items that include the first character, e.g., in real time.

The user may then use a gesture, controller, or other device to select a second character. After selecting the second character, the search may again be refined to include items that contain the first and second characters. In this way, the search may be performed in real time as the characters are selected so the user can quickly locate an item for which the user is searching. Further, the selection of the characters may be intuitive in that gestures may be used to navigate and select the characters without touching a device of the computing device, e.g., through detection of the hand motion using a camera. Selection of characters may be used for a variety of purposes, such as to input specific characters (e.g., “w” or “.com”) as well as to initiate an operation represented by the characters, e.g., “deleted all,” “clear,” and so on. Further discussion of character selection and related techniques (e.g., zooming) may be found in relation to the following sections.

In the following discussion, an example environment is first described that is operable to employ the character selection techniques described herein. Example illustrations of the techniques and procedures are then described, which may be employed in the example environment as well as in other environments. Accordingly, the example environment is not limited to performing the example techniques and procedures. Likewise, the example techniques and procedures are not limited to implementation in the example environment.

Example Environment

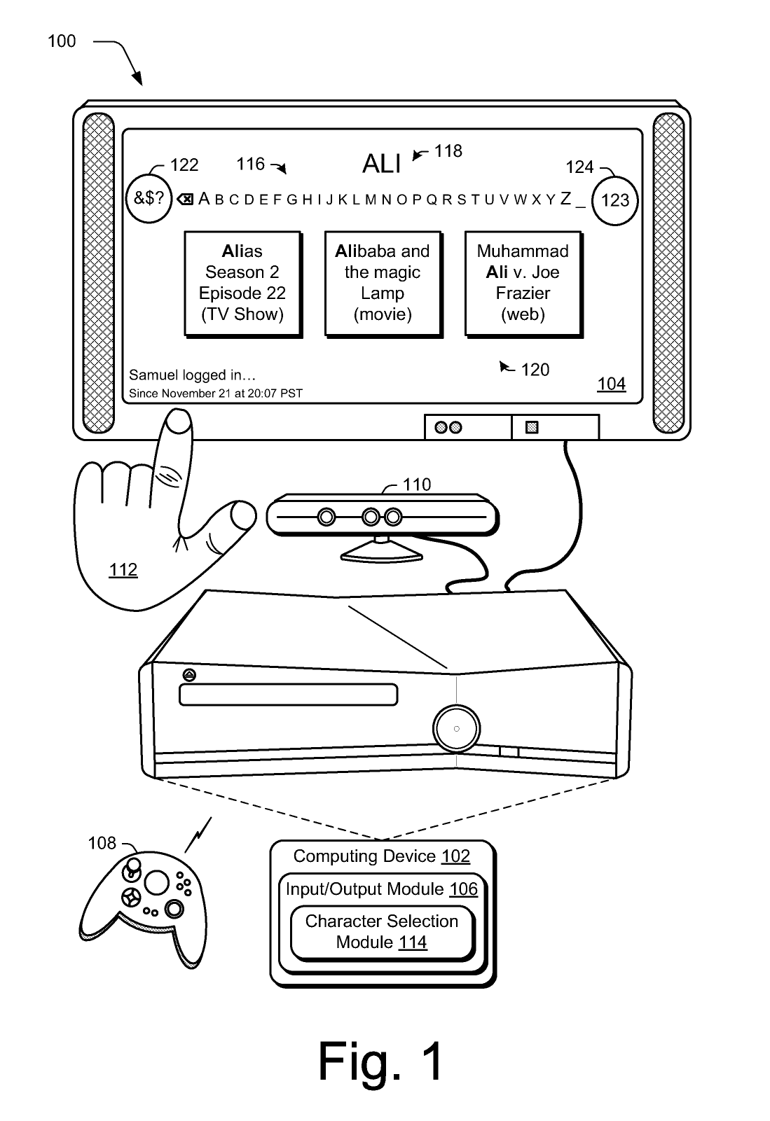

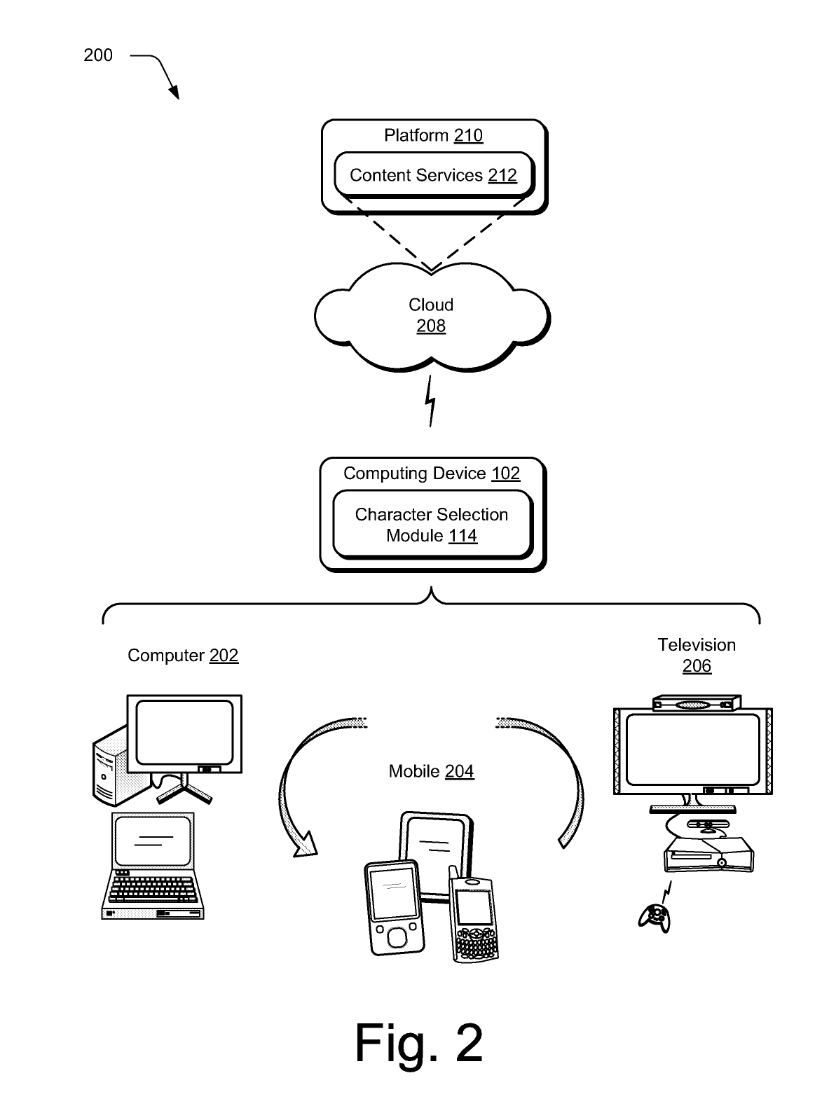

FIG. 1 is an illustration of an environment 100 in an example implementation that is operable to employ character selection techniques. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a game console communicatively coupled to a display device 104 (e.g., a television) as illustrated, a wireless phone, a netbook, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is illustrated as including an input/output module 106. The input/output module 106 is representative of functionality relating to recognition of inputs and/or provision of outputs by the computing device 102. For example, the input/output module 106 may be configured to receive inputs from a keyboard, mouse, to identify gestures and cause operations to be performed that correspond to the gestures, and so on. The inputs may be detected by the input/output module 106 in a variety of different ways.

The input/output module 106 may be configured to receive one or more inputs via touch interaction with a hardware device, such as a controller 108 as illustrated. Touch interaction may involve pressing a button, moving a joystick, movement across a track pad, use of a touch screen of the display device 104 (e.g., detection of a finger of a user's hand or a stylus), and so on. Recognition of the touch inputs may be leveraged by the input/output module 106 to interact with a user interface output by the computing device 102, such as to interact with a game, an application, browse the internet, change one or more settings of the computing device 102, and so forth. A variety of other hardware devices are also contemplated that involve touch interaction with the device. Examples of such hardware devices include a cursor control device (e.g., a mouse), a remote control (e.g. a television remote control), a mobile communication device (e.g., a wireless phone configured to control one or more operations of the computing device 102), and other devices that involve touch on the part of a user or object.

The input/output module 106 may also be configured to provide a natural user interface (NUI) that may recognize interactions that do not involve touch. For example, the computing device 102 may include a NUI input device 110. The NUI input device 110 may be configured in a variety of ways to detect inputs without having a user touch a particular device, such as to recognize audio inputs through use of a microphone. For instance, the input/output module 106 may be configured to perform voice recognition to recognize particular utterances (e.g., a spoken command) as well as to recognize a particular user that provided the utterances.

In another example, the NUI input device 110 that may be configured to recognize gestures, presented objects, images, and so on through use of a camera. The camera, for instance, may be configured to include multiple lenses so that different perspectives may be captured. The different perspectives may then be used to determine a relative distance from the NUI input device 110 and thus a change in the relative distance from the NUI input device 110. The different perspectives may be leveraged by the computing device 102 as depth perception. The images may also be leveraged by the input/output module 106 to provide a variety of other functionality, such as techniques to identify particular users (e.g., through facial recognition), objects, and so on.

The input-output module 106 may leverage the NUI input device 110 to perform skeletal mapping along with feature extraction of particular points of a human body (e.g., 48 skeletal points) to track one or more users (e.g., four users simultaneously) to perform motion analysis. For instance, the NUI input device 110 may capture images that are analyzed by the input/output module 106 to recognize one or more motions made by a user, including what body part is used to make the motion as well as which user made the motion. An example is illustrated through recognition of positioning and movement of one or more fingers of a user's hand 112 and/or movement of the user's hand 112 as a whole. The motions may be identified as gestures by the input/output module 106 to initiate a corresponding operation.

A variety of different types of gestures may be recognized, such a gestures that are recognized from a single type of input (e.g., a hand gesture) as well as gestures involving multiple types of inputs, e.g., a hand motion and a gesture based on positioning of a part of the user's body. Thus, the input/output module 106 may support a variety of different gesture techniques by recognizing and leveraging a division between inputs. It should be noted that by differentiating between inputs in the natural user interface (NUI), the number of gestures that are made possible by each of these inputs alone is also increased. For example, although the movements may be the same, different gestures (or different parameters to analogous commands) may be indicated using different types of inputs. Thus, the input/output module 106 may provide a natural user interface the NUI that supports a variety of user interaction's that do not involve touch.

Accordingly, although the following discussion may describe specific examples of inputs, in instances different types of inputs may also be used without departing from the spirit and scope thereof. Further, although in instances in the following discussion the gestures are illustrated as being input using a NUI, the gestures may be input using a variety of different techniques by a variety of different devices, such as to employ touchscreen functionality of a tablet computer.

The computing device 102 is further illustrated as including a character selection module 114 that is representative of functionality relating to selection of characters for an input. For example, the character selection module 114 may be configured to output a list 116 of characters in a user interface displayed by the display device 104. A user may select characters from the list 116, e.g., using the controller 108, a gesture made by the user's hand 112, and so on. The selected characters 118 are displayed in the user interface and in this instance are also used as a basis for a search. Results 120 of the search are also output in the user interface on the display device 104.

A variety of different searches may be initiated by the character selection module 114, both locally on the computing device 102 and remotely over a network. For example, a search may be performed for media (e.g., for television shows and movies and illustrated, music, games, and so forth), to search the web (e.g., the search results “Muhammad Ali v. Joe Frazier” found via a web search as illustrated), and so on. Additionally, although a search was described the characters may be input for a variety of other reasons, such as to enter a user name and password, to write a text, compose a message, enter payment information, vote, and so on. Further discussion of this and other character selection techniques may be found in relation to the following sections.

FIG. 2 illustrates an example system 200 that includes the computing device 102 as described with reference to FIG. 1. The example system 200 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 200, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the client device 102 may assume a variety of different configurations, such as for computer 202, mobile 204, and television 206 uses. Each of these configurations includes devices that may have generally different constructs and capabilities, and thus the computing device 102 may be configured according to one or more of the different device classes. For instance, the computing device 102 may be implemented as the computer 202 class of a device that includes a personal computer, desktop computer, a multi-screen computer, laptop computer, netbook, and so on.

The computing device 102 may also be implemented as the mobile 202 class of device that includes mobile devices, such as a mobile phone, portable music player, portable gaming device, a tablet computer, a multi-screen computer, and so on. The computing device 102 may also be implemented as the television 206 class of device that includes devices having or connected to generally larger screens in casual viewing environments. These devices include televisions, set-top boxes, gaming consoles, and so on. The character selection techniques described herein may be supported by these various configurations of the client device 102 and are not limited to the specific examples of character selection techniques described herein.

The cloud 208 includes and/or is representative of a platform 210 for content services 212. The platform 210 abstracts underlying functionality of hardware (e.g., servers) and software resources of the cloud 208. The content services 212 may include applications and/or data that can be utilized while computer processing is executed on servers that are remote from the client device 102. Content services 212 can be provided as a service over the Internet and/or through a subscriber network, such as a cellular or Wi-Fi network.

The platform 210 may abstract resources and functions to connect the computing device 102 with other computing devices. The platform 210 may also serve to abstract scaling of resources to provide a corresponding level of scale to encountered demand for the content services 212 that are implemented via the platform 210. Accordingly, in an interconnected device embodiment, implementation of functionality of the character selection module 114 may be distributed throughout the system 200. For example, the character selection module 114 may be implemented in part on the computing device 102 as well as via the platform 210 that abstracts the functionality of the cloud 208.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the character selection techniques described below are platform-independent, meaning that the techniques may be implemented on a variety of commercial computing platforms having a variety of processors.

Character Selection Implementation Example

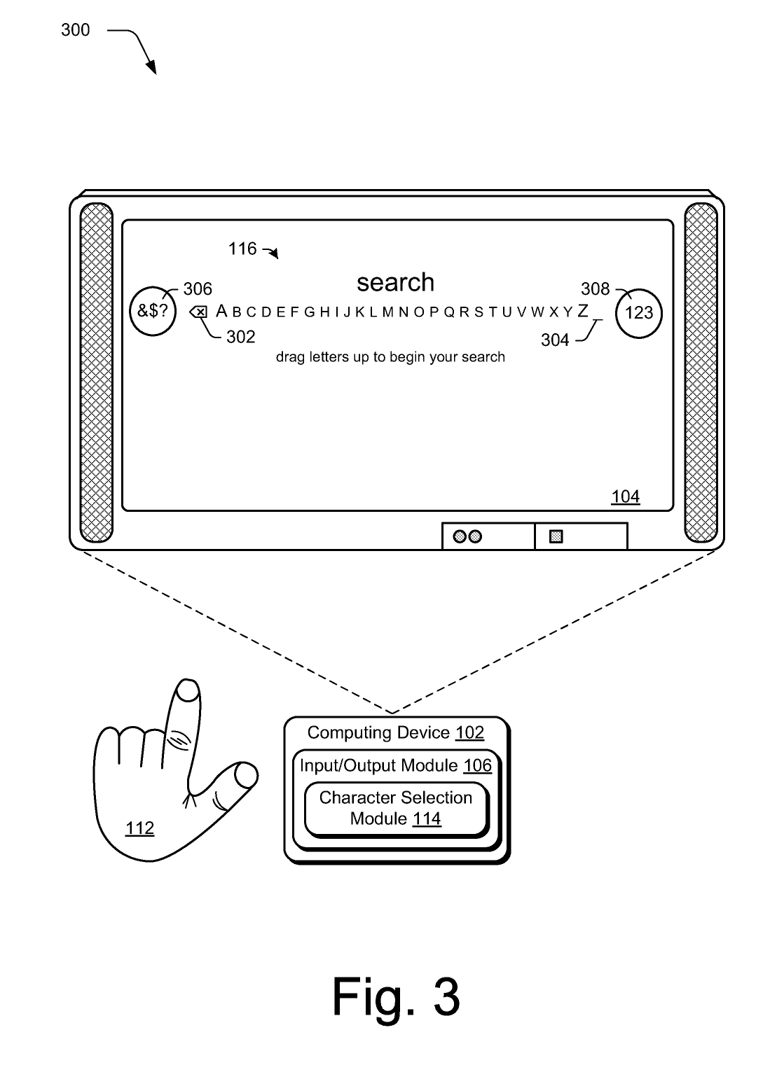

FIG. 3 illustrates a system 300 in an example implementation in which an initial search screen is output in a display device that is configured to receive characters as an input to perform a search. In the illustrated example, the list 116 of characters of FIG. 1 is displayed. In the list 116, the characters “A” and “Z” are displayed as bigger than other characters of the list 116 to give a user an indication of a beginning and end of letters in the list 116. The list 116 also includes a character indicating “space” and “delete,” which are treated as members of the list 116.

When a character in a list 116 is engaged, the entire list 116 may become engaged. In an implementation, an engaging zone may be defined as an area near the characters in the list such as between a centerline through each of the characters in a group and a defined area above it. In this way, a user may navigate between multiple lists.

The user interface output by the character selection module 114 also includes functionality to select other non-alphabetic characters. For example, the user interface as illustrated includes a button 306 to select symbols, such as “&,” “$,” and “?.” The user, for instance, may select this button 306 to cause output of a list of symbols through which the user may navigate using the techniques described below. Likewise, the user may select a button 308 to output a list of numeric characters. A user may interact with the characters in a variety of ways, an example of which may be found in relation to the following figure.

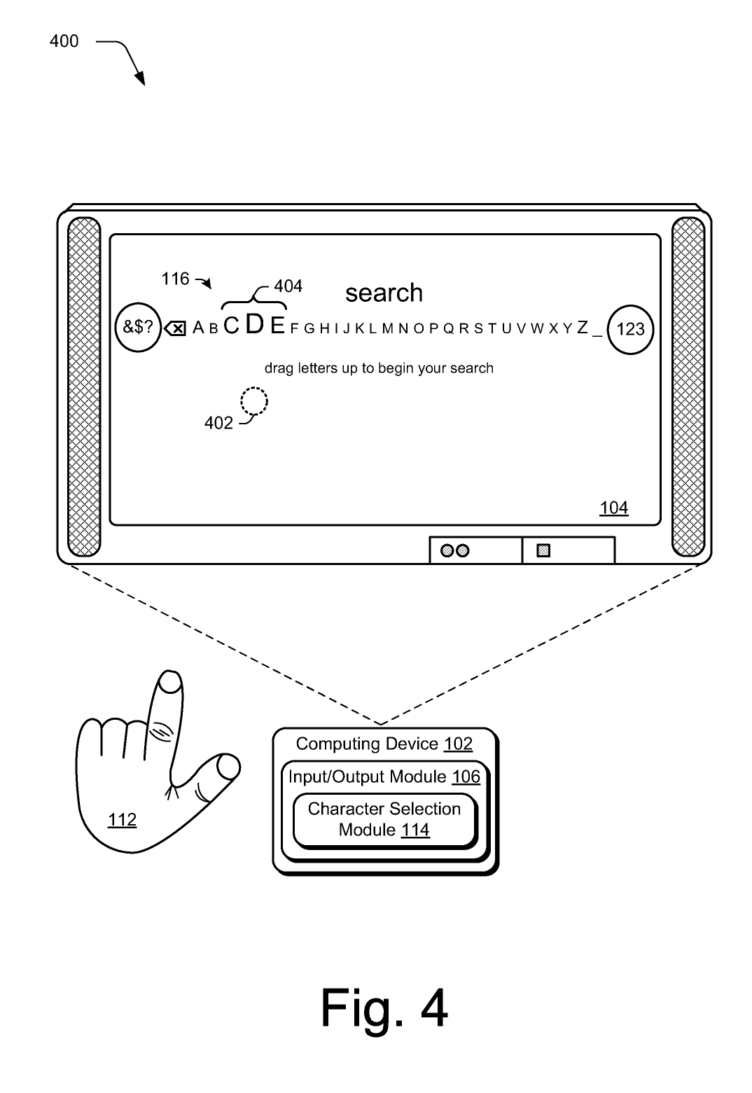

FIG. 4 illustrates a system 400 in an example implementation in which a gesture involving navigation through a list of characters of FIG. 3 is shown. In the user interface of FIG. 4, an indication 402 is output by the character selection module 114 that corresponds to a current position registered for the user's hand 112 by the computing device 102.

For example, the NUI input device 110 of FIG. 1 of the computing device 102 may use a camera to detect a position of the user's hand and provide an output for display in the user interface that indicates “where” in the user interface the user's hand 112 position relates. In this way, the indication 402 may provide feedback to a user to navigate through the user interface. A variety of other examples are also contemplated, such as to give “focus” to areas in the user interface that correspond to the position of the user's hand 112.

In this example, a section 404 of the characters that correspond to the position of the user's hand 112 is displayed as bulging thereby giving the user a preview of the area of the list 116 with which the user is currently interacting. In this way, the user may navigate horizontally through the list 116 using motions of the user's hand 112 to locate a desired character in the list. Further, the section 404 may further provide feedback for “where the user is located” in the list 116 to choose a desired character.

For example, each displayed character may have two ranges associated with it, such as an outer approaching range and an inner snapping range, that may cause the character selection module 114 to respond accordingly when the user interacts with the character within those ranges. For example, when a finger of the user's hand 112 is within the outer approaching range, the corresponding character may be given focus, e.g., expand in size as illustrated, change color, highlighting, and so one. When a finger of the user's hand is within the snapping range of a character (which may be defined as involving an area on the display device 104 that is larger than the display of the character), a display of the indication 402 on the display device 104 may snap to within a display of the corresponding character. Other techniques are also contemplated to give the user a more detailed view of the list 116, an example of which is described in relation to the following figure.

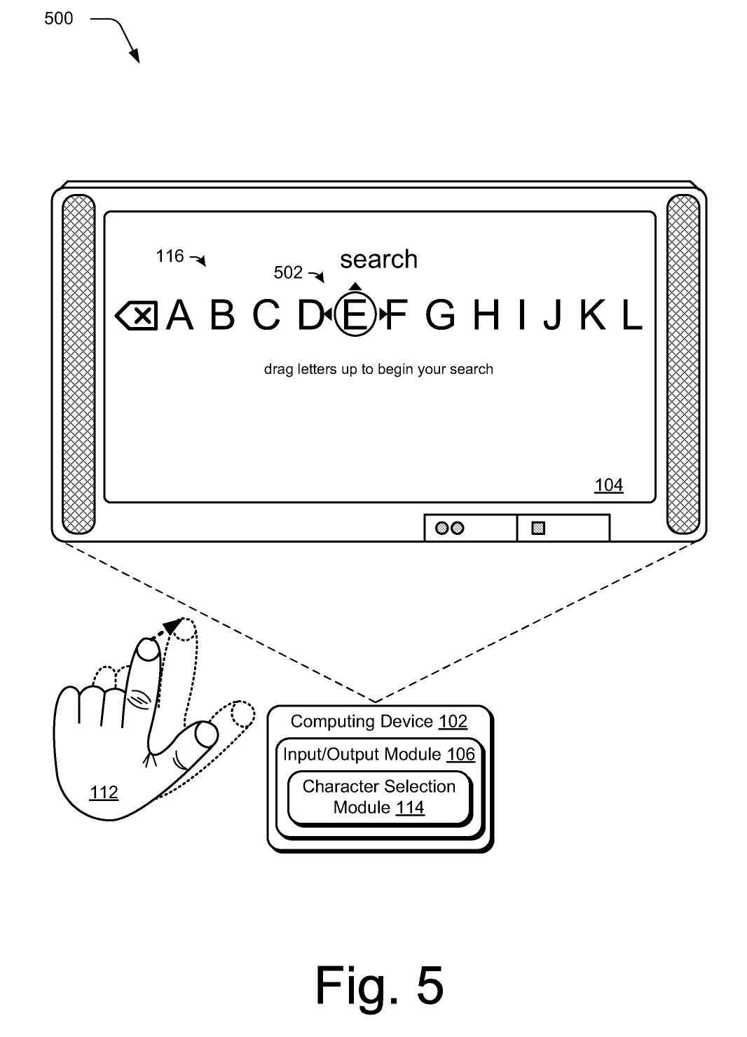

FIG. 5 illustrates a system 500 in an example implementation in which a gesture that involves a zoom of the list of characters 116 of FIG. 4 is shown. In this example, the character selection module 114 of the computing device 102 detects movement of the user's hand 112 towards the computing device 102, e.g., approaching a camera of the NUI input device 110 of FIG. 1. This is illustrated in FIG. 5 through the use of a phantom lines and an arrow associated with the user's hand 112.

From this input, the character selection module 114 recognizes a zoom gesture and accordingly displays a portion of the list 116 as expanded in FIG. 5 as may be readily seen in comparison with a non-expanded view shown in FIGS. 3 and 4. In this way, a use may view a section of the list 116 in greater detail and make selections from the list 116 using less-precise gestures in a more efficient manner. For example, the user may then navigate through the expanded list 116 using horizontal gestures without exhibiting the granularity of control that would be exhibited in interacting with the non-expanded view of the list 116 in FIGS. 3 and 4.

In the illustrated example, the indication 402 and the ‘bulging” letters of the section 404 of the list 116 have met. Accordingly, the character selection module 114 may recognize that the user is engaged with the list 116 and display corresponding navigation that is permissible from that engagement, as indicated 502 by the circle around the “E” and corresponding arrows indicating permissible navigation directions. In this way, the user's hand 112 may be moved through the expanded list 116 to select letters.

In at least some embodiments, when the user's hand 112 stays above the initial engagement plane, display of the list 116 remains in a zoomed state. Further, the amount of zoom applied to the display of the list 116 may be varied based on an amount of distance the user's hand 112 has approached the computing device 102, e.g., the NUI input device 110 of FIG. 1. In this way, the user's hand may be moved closer to and further away from the computing device 102 to control an amount of zoom applied to a user interface output by the computing device 102, e.g., to zoom in or out. A user may then select one or more of the characters to be used as an input by the computing device 102, further discussion of which may be found in relation to the following figure.

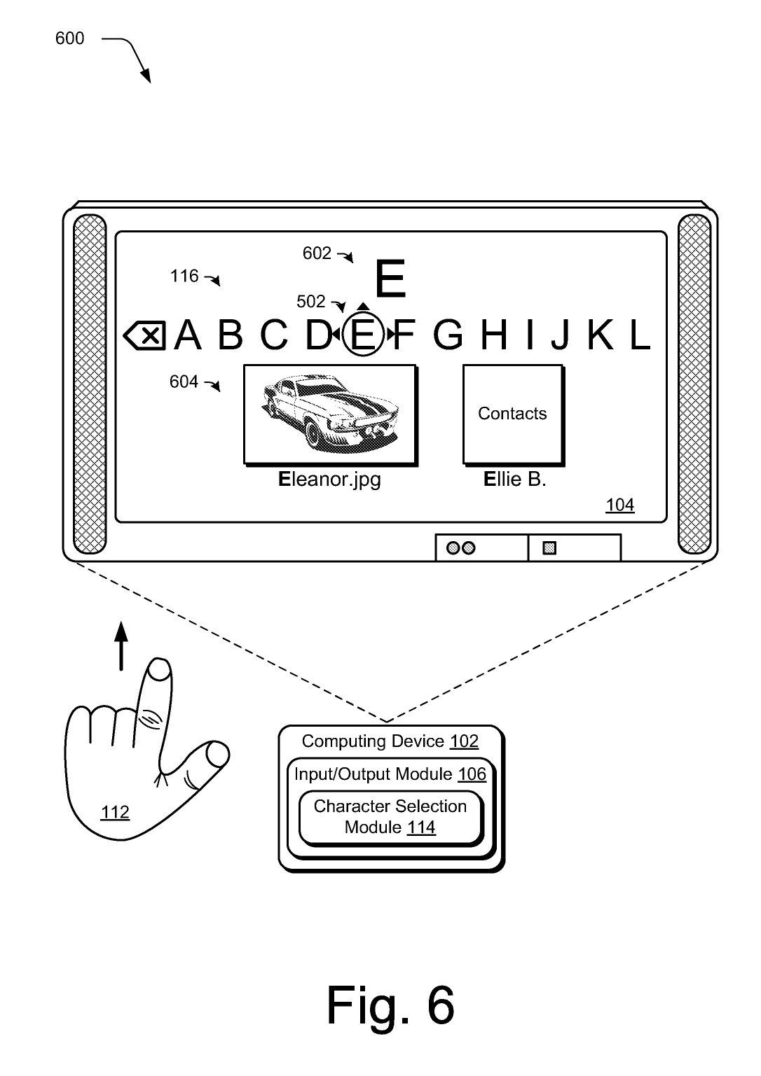

FIG. 6 illustrates an example system 600 in which a gesture that involves selection of a character from the list of FIG. 5 to perform a search is shown. The list 116 is displayed in an zoomed view in this example as previously described in relation to FIG. 5, although selection may also be performed in other views, such as the views shown in FIGS. 3 and 4.

In this example, vertical movement of the user's hand 112 (e.g., “up” in this example as illustrated by the arrow) is recognized as selecting a character (e.g., the letter “E”) that corresponds to a current position of the user's hand 112. The letter “E” is also indicated 502 as having focus using a circle and arrows showing permissible navigation as previously described in relation to FIG. 5. A variety of other techniques may also be employed to select a character, e.g., a “push” toward the display device, holding a cursor over an object of a predefined amount of time, and so on.

Selection of the character causes the character selection module 114 to display the selected character 602 to provide feedback regarding the selection. Additionally, the character selection module 114 in this instance is utilized to initiate a search using the character, results 604 of which are output in real time in the user interface. The user may drop their hand 112 to disengage from the list 116, such as to browse the results 604.

As previously described, a variety of different searches may be performed, including an image and contact as illustrated in this example, media, an internet search, and so on. Further, although searches have been described the techniques described herein may be employed to enter characters for a variety of purposes, such as to compose messages, enter data in a form, provide billing information, edit documents, and so on. Yet further, although a generally linear list was shown in FIGS. 3-6, the list 116 may be configured in a variety of ways, examples of which may be found in relation to the following figures.

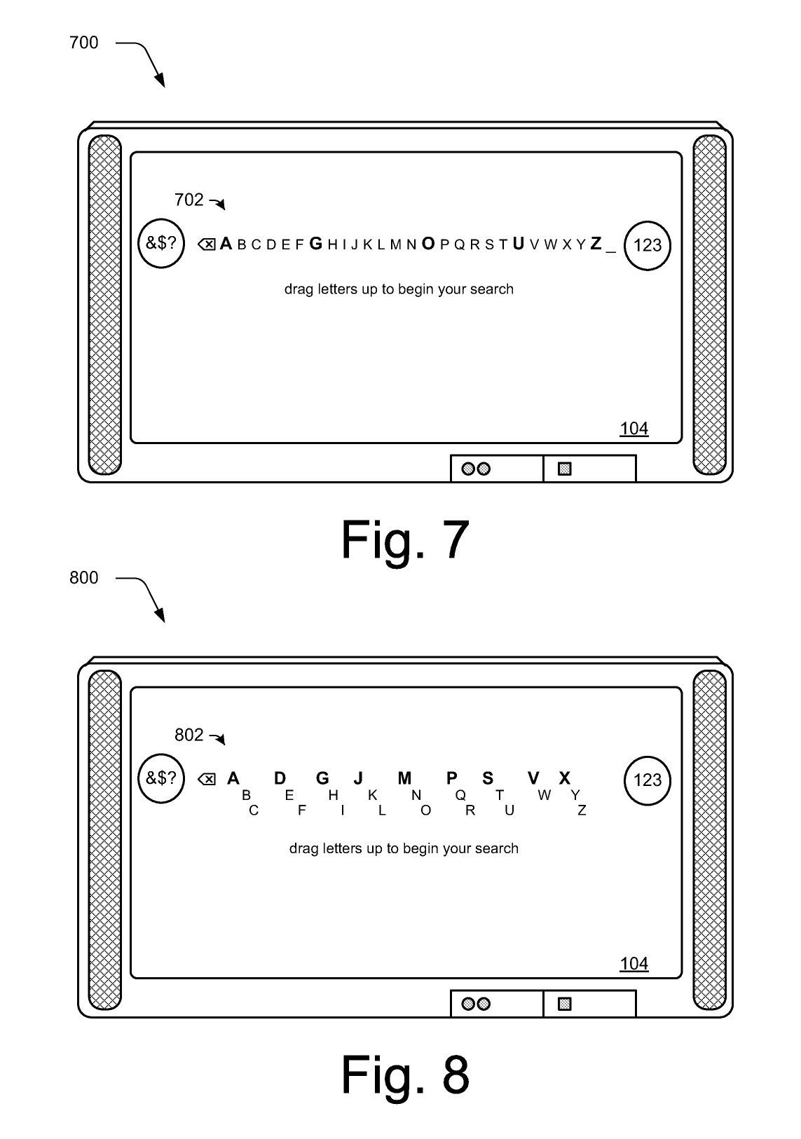

Characters may be displayed on the display device 104 in a variety of ways for user selection. In the example of FIG. 5, characters are displayed the same as the characters around it. Alternatively, as shown in the example system 700 of FIG. 7, one or more characters may be enlarged or given other special visual treatment called a group prime. A group prime may be used to help a user quickly navigate through a larger list of characters. As shown in the example list 702, the letters “A” through “Z” are members of an expanded list of characters. The letters “A,” “G,” “O,” “U,” and “Z” are given special visual treatment such that a user may quickly locate a desired part of the list 702. Other examples are also contemplated, such as a marquee representation that is displayed behind a corresponding character that is larger than its peers.

Additionally, although a linear display of characters was shown, a variety of other configurations of the characters in the list are also contemplated. As shown in the example system 800 of FIG. 8, a list 802 may be configured to include characters that are arranged in staggered groups. Each group may be associated with a group prime that is displayed in a horizontal row. Other non-linear configurations are also contemplated, such as a circular arrangement.

Further, although alphabetic characters have been described for use in a Latin-based language, the character selection module 114 may support a variety of other languages. For example, the character selection module 114 may support syllabic writing techniques (e.g., Kana) in which syllables are written out using one or more characters and a search result includes possible words that correspond to the syllables.

Yet further, although the previous figures described navigation of the list 116 using gestures, a variety of other techniques may also be utilized to select characters. For example, a user may interact with the controller 108 (e.g., manually handling the controller), a remote control, and so on to navigate, zoom, and select characters as previously described in relation to the gestures.

For instance, the user may navigate left or right using a joystick, thumb pad, or other navigation feature. Letters on the display device 104 may become enlarged when in focus using the “bulging” technique previously described in relation to FIG. 4. The controller 108 may also provide additional capabilities to navigate such as buttons for delete or space.

In an implementation, the user move between groups of characters with navigating through the individual characters. For example, the user may use a right pushbutton of the controller 108 to enable focus shifts between groups of characters. In another example, the right pushbutton may enable movement through multiple characters in the list 116, such as five characters at a time with a single button press. Additionally, if there are less than 5 characters in the group, the button press may move the focus to the next group. Similarly, a left pushbutton may move the focus to the left. A variety of other examples are also contemplated.

Example Procedure

The following discussion describes character selection techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200-800 of FIGS. 2-8.

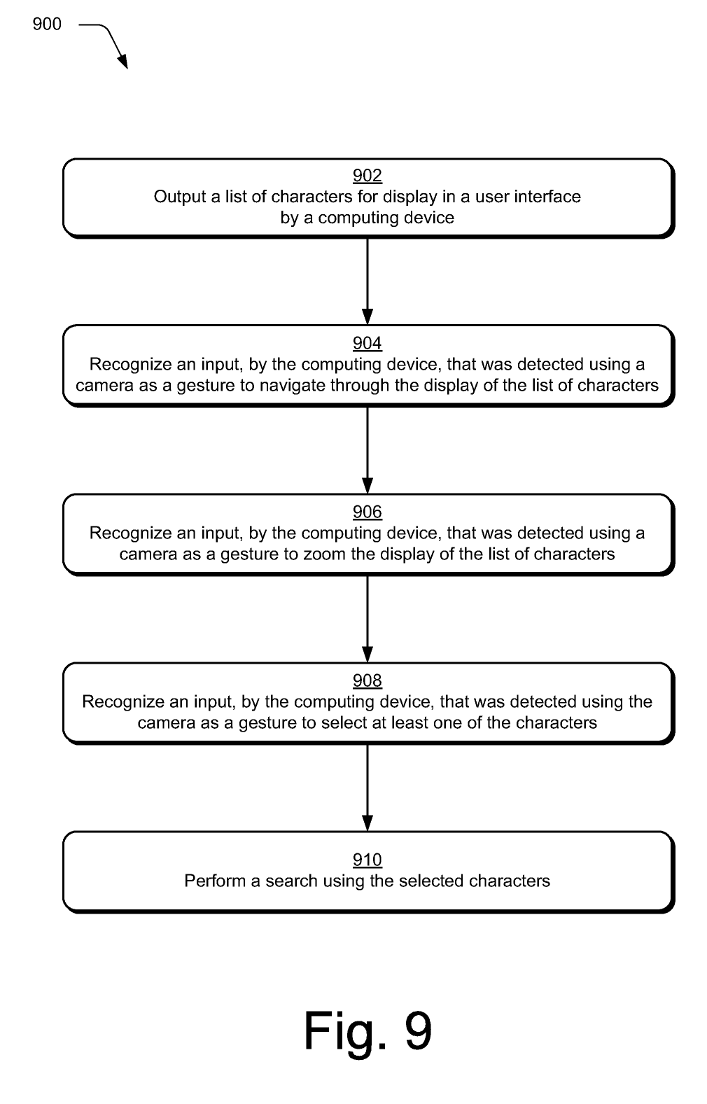

FIG. 9 depicts a procedure 900 in an example implementation in which gestures are utilized to navigate, zoom, and select characters. A list of characters is output for display in a user interface by a computing device (block 902). The list may be configured in a variety of ways, such as linear and non-linear, include a variety of different characters (e.g., numbers, symbols, alphabetic characters, characters from non-alphabetic languages), and so on.

An input is recognized, by the computing device, that was detected using a camera as a gesture to navigate through the display of the list of characters (block 904). For example, a camera of the NUI input device 110 of the computing device 102 may capture images of horizontal movement of a user's hand 112. These images may then be used by the character selection module 114 as a basis to recognize the gesture to navigate through the list 116. The gesture, for instance, may involve movement of the user's hand 112 that is made parallel to a longitudinal axis of the list, e.g., “horizontal” for list 116, list 702, and list 802.

Another input is recognized, by the computing device, that was detected using the camera as a gesture to zoom the display of the list of characters (block 906). Like above, the character selection module 114 may use images captured by a camera of the NUI input device 110 as a basis to recognize movement towards the camera. Accordingly, the character selection module 114 may cause a display of characters in the list to increase in size on the display device 104. Further, the amount of the increase may be based at least in part on the amount of movement toward the camera that was detected by the character selection module 114.

A further input is recognized, by the computing device, that was detected using the camera as a gesture to select at least one of the characters (block 908). Continuing with the previous example, the gesture in this example may be perpendicular to a longitudinal axis of the list, e.g., “up” for list 116, list 702, and list 802. Thus, a user may motion horizontally with their hand to navigate through a list of characters, may motion toward the camera to zoom the display of the list of characters, and move up to select the characters. In an implementation, users may move their hand down to disengage from interaction with the list.

A search is performed using the selected characters (block 910). For example, a user may specify a particular search to be performed, e.g., for media stored locally on the computing device 102 and/or available via a network, to search a contact list, perform a web search, and so forth. As previously described, the character selection module 114 may also provide the character selection techniques for a variety of other purposes, such as to compose messages, provide billing information, edit documents, and so on. Thus, the character selection module 114 may support a variety of different techniques to interact with characters in a user interface.

Example Device

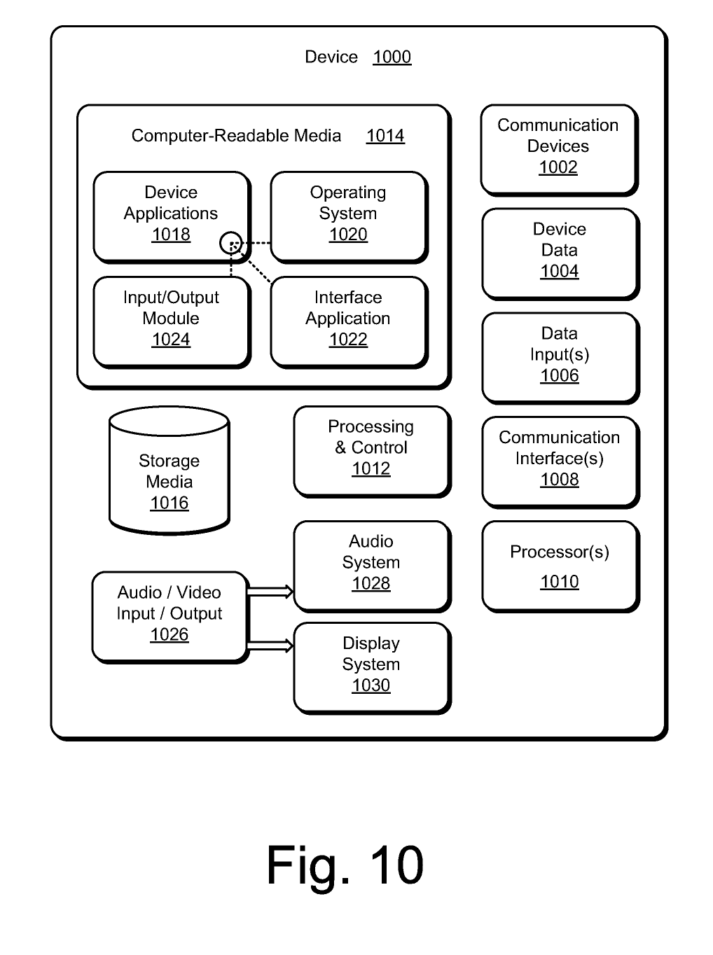

FIG. 10 illustrates various components of an example device 1000 that can be implemented as any type of portable and/or computer device as described with reference to FIGS. 1-8 to implement embodiments of the gesture techniques described herein. Device 1000 includes communication devices 1002 that enable wired and/or wireless communication of device data 1004 (e.g., received data, data that is being received, data scheduled for broadcast, data packets of the data, etc.). The device data 1004 or other device content can include configuration settings of the device, media content stored on the device, and/or information associated with a user of the device. Media content stored on device 1000 can include any type of audio, video, and/or image data. Device 1000 includes one or more data inputs 1006 via which any type of data, media content, and/or inputs can be received, such as user-selectable inputs, messages, music, television media content, recorded video content, and any other type of audio, video, and/or image data received from any content and/or data source.

Device 1000 also includes communication interfaces 1008 that can be implemented as any one or more of a serial and/or parallel interface, a wireless interface, any type of network interface, a modem, and as any other type of communication interface. The communication interfaces 1008 provide a connection and/or communication links between device 1000 and a communication network by which other electronic, computing, and communication devices communicate data with device 1000.

Device 1000 includes one or more processors 1010 (e.g., any of microprocessors, controllers, and the like) which process various computer-executable instructions to control the operation of device 1000 and to implement embodiments described herein. Alternatively or in addition, device 1000 can be implemented with any one or combination of hardware, firmware, or fixed logic circuitry that is implemented in connection with processing and control circuits which are generally identified at 1012. Although not shown, device 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1000 also includes computer-readable media 1014, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1000 can also include a mass storage media device 1016.

Computer-readable media 1014 provides data storage mechanisms to store the device data 1004, as well as various device applications 1018 and any other types of information and/or data related to operational aspects of device 1000. For example, an operating system 1020 can be maintained as a computer application with the computer-readable media 1014 and executed on processors 1010. The device applications 1018 can include a device manager (e.g., a control application, software application, signal processing and control module, code that is native to a particular device, a hardware abstraction layer for a particular device, etc.). The device applications 1018 also include any system components or modules to implement embodiments of the gesture techniques described herein. In this example, the device applications 1018 include an interface application 1022 and an input/output module 1024 (which may be the same or different as input/output module 114) that are shown as software modules and/or computer applications. The input/output module 1024 is representative of software that is used to provide an interface with a device configured to capture inputs, such as a touchscreen, track pad, camera, microphone, and so on. Alternatively or in addition, the interface application 1022 and the input/output module 1024 can be implemented as hardware, software, firmware, or any combination thereof. Additionally, the input/output module 1024 may be configured to support multiple input devices, such as separate devices to capture visual and audio inputs, respectively.

Device 1000 also includes an audio and/or video input-output system 1026 that provides audio data to an audio system 1028 and/or provides video data to a display system 1030. The audio system 1028 and/or the display system 1030 can include any devices that process, display, and/or otherwise render audio, video, and image data. Video signals and audio signals can be communicated from device 1000 to an audio device and/or to a display device via an RF (radio frequency) link, S-video link, composite video link, component video link, DVI (digital video interface), analog audio connection, or other similar communication link. In an embodiment, the audio system 1028 and/or the display system 1030 are implemented as external components to device 1000. Alternatively, the audio system 1028 and/or the display system 1030 are implemented as integrated components of example device 1000.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
outputting a list of characters for display in a user interface by a computing device; and
recognizing an input, by the computing device, that was detected using a camera as a gesture to select at least one of the characters.

2. A method as described in claim 1, further comprising performing a search using the selected at least one of the characters.

3. A method as described in claim 2, wherein the performing of the search is performed in real time as the selected at least one of the characters are recognized and further comprising outputting a result of the performed search.

4. A method as described in claim 1, further comprising outputting the list of characters for display in the user interface such that one or more of the characters that are positioned on the user interface as corresponding to a current input point of the gesture as displayed as having an increased size as compared to at least one other said character of the list that does not correspond to the current input point of the gesture.

5. A method as described in claim 1, further comprising recognizing an input, by the computing device, that was detected using the camera as a gesture to navigate through the display of the list of characters.

6. A method as described in claim 5, wherein the gesture to navigate through the display of the list of characters involves horizontal movement of a user and the gesture to select the at least one of the characters involves vertical movement.

7. A method as described in claim 1, further comprising recognizing an input, by the computing device, that was detected using the camera as a gesture to zoom the display of the list of characters.

8. A method as described in claim 7, wherein an amount of zoom applied to the display is based at least in part on an amount of the movement towards the camera.

9. A method as described in claim 1, wherein the characters are included in a list and describe operations to be performed upon selection of the characters.

10. A method as described in claim 1, wherein the recognizing of the gesture involves recognizing positioning of one or more body parts of a user.

11. A method as described in claim 1, wherein the gesture is detected without physically touching the computing device.

12. A method comprising:
recognizing an input, by a computing device, that was detected using a camera as a gesture to select at least one of a plurality of characters displayed by the computing device; and
performing a search using the selected at least one of the plurality of characters.

13. A method as described in claim 12, wherein the performing of the search is performed in real time as the selected at least one of the characters are recognized and further comprising outputting a result of the performed search.

14. A method as described in claim 12, further comprising recognizing an input, by the computing device, that was detected using the camera as a gesture to navigate through the display of the list of characters and wherein the gesture to navigate through the display of the list of characters involves horizontal movement of a user and the gesture to select the at least one of the characters involves vertical movement.

15. A method as described in claim 12, further comprising recognizing an input, by the computing device, as movement towards the camera as a gesture to zoom the display of the list of characters and wherein an amount of zoom applied to the display is based at least in part on an amount of the movement towards the camera.

16. One or more computer-readable media comprising instructions that, responsive to execution on a computing device, cause the computing device to perform operations comprising:
recognizing a first input that was detected using a camera that involves a first movement of a hand as a navigation gesture to navigate through a listing of characters displayed by a display device of the computing device;
recognizing a second input that was detected using the camera that involves a second movement of the hand as a zoom gesture to zoom the display of the characters; and
recognizing a third input that was detected using the camera that involves a third movement of the hand as a selection gesture to select at least one of the characters.

17. One or more computer-readable media as described in claim 16, wherein the instructions are further configured to perform operations comprising outputting the list of characters for display in the user interface such that one or more of the characters that are positioned on the user interface as corresponding to a current input point of the navigation gesture as displayed as having an increased size as compared to at least one other said character of the list that does not correspond to the current input point of the navigation gesture.

18. One or more computer-readable media as described in claim 16, wherein an amount of zoom applied to the display is based at least in part on an amount of the movement towards the camera in the zoom gesture.

19. One or more computer-readable media as described in claim 16, wherein the navigation gesture involves horizontal movement of the hand and the selection gesture involves vertical movement of the hand.

20. One or more computer-readable media as described in claim 16, wherein at least one of the first input, the second input, or the third input is provided using the hand of a user that is different than the hand of the user used for other said inputs.
